(19) United States
(12) Patent Application Publication
(10) Pub. No.: US 2015/0354803 A1
(43) Pub. Date: Dec. 10, 2015

(54) KIND OF LIGHT EMITTING DIODE LUMINAIRE

(71) Applicant: Shenzhen Yaorong Technology Co., Ltd., Shenzhen (CN)

(72) Inventors: Huanhuan YU, Shenzhen (CN); Ying YONG, Shenzhen (CN)

(73) Assignee: SHENZHEN YAORONG TECHNOLOGY CO., LTD., Shenzhen (CN)

(21) Appl. No.: 14/733,941

(22) Filed: Jun. 8, 2015

(30) Foreign Application Priority Data
Jun. 9, 2014 (CN) 2014 203 063 71.8

(51) Int. Cl. F21V 29/83; F21V 29/89; F21V 31/00; F21V 5/04; F21V 23/02

(52) U.S. Cl. CPC F21V 29/83; F21V 5/048; F21V 23/02; F21V 31/005; F21V 29/89; F21Y 2101/02

(57) ABSTRACT

A kind of Light Emitting Diode (LED) luminaire comprises a radiator, a power source and a plurality of LED light sources. The power source is connected with the LED light sources electrically; the power source is installed on the radiator which is equipped with holes to make its top and bottom connected. The LED luminaire is equipped with an adapter assembly comprising a first adapter and a second adapter, which are rotatably and movably connected through a tooth profile structure. The first adapter is fixed on the radiator; when in use, the second adapter is fixed with the outside. The LED luminaire further comprises a lens module board, which is fixed on the bottom of the radiator, covers the LED light sources, and is sealed by a waterproof ring, with one lens covering one LED light source. The lens on the lens module board is a polarized distribution lens.

### CROSS REFERENCE TO RELATED APPLICATIONS

The present application is the claims priority to Chinese Utility Model CN201420306371.8 filed on Jun. 9, 2014.

### TECHNICAL FIELD

The present invention relates to the field of luminaire, specially relates to a kind of Light Emitting Diode (LED) luminaire.

### BACKGROUND ART

The Light Emitting Diode (LED) luminaire in existence is not convenient for air convection, nor for timely discharge of hot-air, and heat dissipation effect is poor. In addition, the overall structure is fixed and it is not convenient to adjust the angle. Furthermore, the lenses of the LED luminaire in existence are individual ones, with the glass panel separating the lenses from the outside. Though the purpose of waterproofing is achieved, the structure is not simple.

### CONTENT OF THE INVENTION

For the above mentioned defects, the invention aims to providing a kind of Light Emitting Diode luminaire with better heat dissipation effect, convenient for adjusting angle, with simple structure and good lighting effect; effectively solving the problems in prior art such as poor heat dissipation effect, inconvenience of adjusting the angle, not simple structure, and poor lighting effect, etc..

To solve the above mentioned technical problems, the technical proposal used in this invention is as follows: a Light Emitting Diode luminaire, comprising a radiator, power source and a plurality of Light Emitting Diode light sources; the power source connected with the light sources electrically; the power source is installed on the radiator, the radiator is equipped with through-holes to make its top and bottom connected, forming air convection and facilitating heat exchange, achieving better heat dissipation effect.

Preferably, the radiator is equipped with a plurality of heat sinks with a gap between two neighboring heat sinks, allowing for speedup of heat dissipation.

Preferably, the Light Emitting Diode luminaire is equipped with an adapter assembly, one end of the adapter assembly fixed on the radiator; and when in use, the other end of the adapter assembly is fixed with the outside, for example, on the wall.

Preferably, the adapter assembly comprises a first adapter and a second adapter; the first adapter is fixed on the radiator, and the first adapter is connected to the second adapter through the rotating activity connection; and when in use, the second adapter is fixed with the outside.

Preferably, the first adapter and the second adapter have tooth structures, and the two adapters are connected through rotating activity of the tooth structures, allowing for adjustment of the angle.

Preferably, the first adapter is fixed on the radiator by a silicone pad, and the first adapter can connect to the second adapter by a silicone ring through rotating activity.

Preferably, the Light Emitting Diode luminaire further comprises a lens module board and an aluminum substrate, the Light Emitting Diode light sources are all evenly distributed on the aluminum substrate, which is fixed on the bottom of the radiator; the number of the lenses on the lens module board is equal to the number of the Light Emitting Diode light sources; the lens module board covers the

Light Emitting Diode light sources and is sealed by a waterproofring, with one lens covering one Light Emitting Diode light source. The lens module board is fixed on the bottom of the radiator. The structure adopts waterproof and optical integrated design, with simple and elegant outlook.

Preferably, the lenses on the lens module board are polarized lenses, making light scattered at a larger area.

Preferably, the material of the radiator is aluminum or copper etc., speeding up the heat dissipation.

Preferably, the power source is equipped with lighting arrester.

Preferably, the said Light Emitting Diode luminaire is provided with a fixed adapter, one end of the fixed adapter fixed on the radiator, and the other end of the fixed adapter is fixed on the outside.

Compared with prior art, this invention has the following beneficial effects:

1) The radiator of the Light Emitting Diode luminaire is equipped with through-holes which makes its top and bottom connected, forming air convection and facilitating air exchange. It is also designed with a plurality of heat sinks, with gap between them, allowing for speedup of heat dissipation and better heat dissipation effect;

2) Light Emitting Diode luminaire is equipped with adapter assembly which comprises the first adapter and the second adapter; they are connected through rotating activity of tooth structures, allowing for adjustment of the angle.

3) Light Emitting Diode luminaire comprises a lens module board which adopts the waterproof and optical integrated design, with simple and elegant outlook. A very good waterproof effect is achieved without using glass board to separate the lenses and the outside.

4) The lenses on the lens module board are polarized lenses, producing polarized distribution light for large angle of lighting, achieving scattered lighting, having large lighting range.

5) The installment of lighting arrester increases the safety and improves the working life of LED luminaire.

### DESCRIPTION OF FIGURES

FIG. 1 is a schematic diagram of the invention Light Emitting Diode luminaire;

FIG. 2 is a decomposition diagram of specific example of the invention Light Emitting Diode luminaire (only main components displayed in the figures);

FIG. 3 is a view of the invention Light Emitting Diode luminaire;

FIG. 4 is another schematic diagram of the invention Light Emitting Diode luminaire;

FIG. 5 is a decomposition diagram of one of embodiments of the invention Light Emitting Diode luminaire (only main components displayed in the figures);

FIG. 6 is a schematic diagram of one of embodiments of the invention Light Emitting Diode luminaire;

FIG. 7 is a view of one of embodiments of the invention Light Emitting Diode luminaire;

FIG. 8 is a view of one of embodiments of the invention Light Emitting Diode luminaire.

### DETAILED EMBODIMENTS

In order to better understanding the invention, the invention is further described with combination of the figures and embodiments.

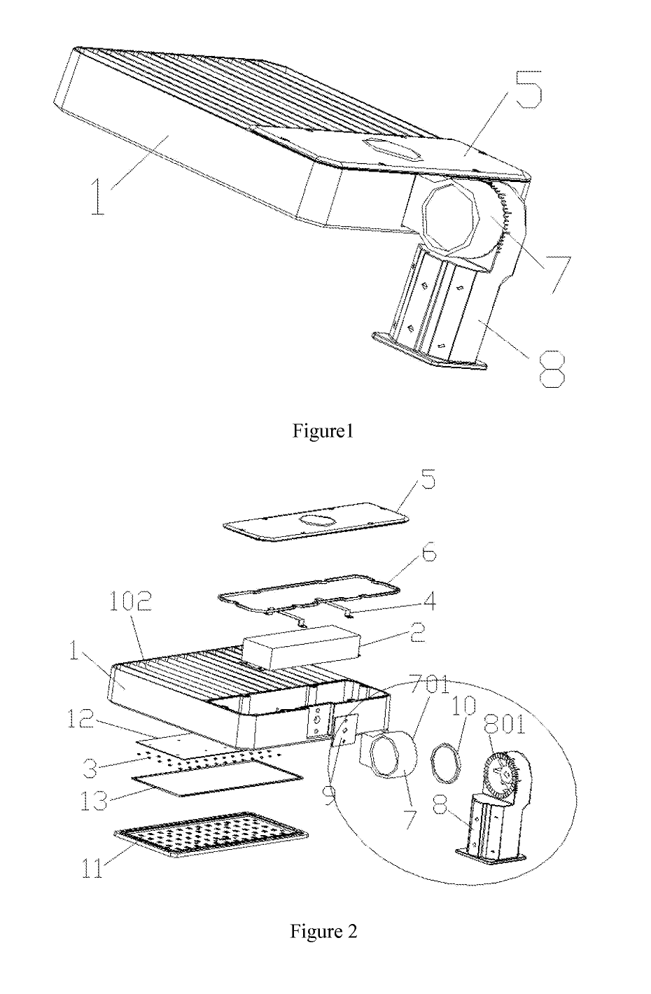

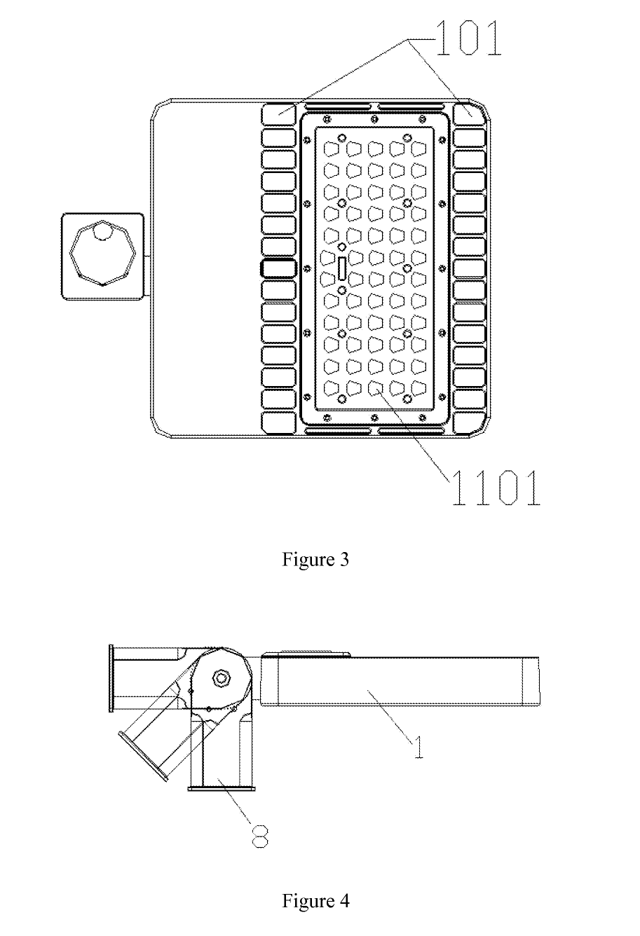

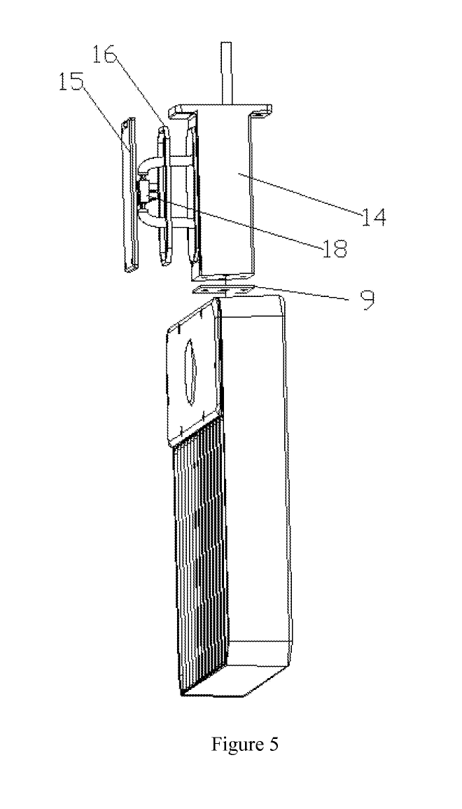

Please refer to FIG. 1, FIG. 2, FIG. 3 and FIG. 4, the invention Light Emitting Diode luminaire comprises radiator 1, power source 2, a plurality of Light Emitting Diode light sources 3, the power source 2 is connected with the Light Emitting Diode light sources 3 electrically; the power source 2 is installed on the radiator 1, and can be fixed by power strip 4, and covered by the cover of power box 5 and silicone ring of power box 6; the radiator 1 is equipped with through-holes 101 to make its top and bottom connected, forming air convection and facilitating air exchange, achieving good heat dissipation effect. The radiator 1 can have a number of heat sinks 102, with gaps between them, allowing for speedup of heat dissipation. The material of radiator 1 can be aluminum or copper etc., allowing for acceleration of heat dissipation.

The Light Emitting Diode luminaire is equipped with adapter assembly, one end of the adapter assembly is fixed on the radiator, when used, the other end of the adapter assembly is fixed with the outside. The adapter assembly comprises the first adapter 7 and the second adapter 8, the first adapter 7 is fixed on the radiator, and the first adapter is connected to the second adapter through rotating activity connection; when used, the second adapter 8 is fixed with the outside, for example, fixed with the wall. The first adapter 7 and the second adapter 8 have tooth structures 701, 801, and the two adapters are connected through rotating activity of tooth structures, facilitating the adjustment of angle. The first adapter 7 is fixed on the radiator 1 by silicone pad 9, and the first adapter 7 rotating activity connect to the second adapter by silicone ring 10.

The Light Emitting Diode luminaire also comprises the lens module board 11 and the aluminum substrate 12; the Light Emitting Diode light sources 3 are all evenly distributed on the aluminum substrate 12, for example, uniformly distributed and welded on the aluminum substrate 12. The aluminum substrate is fixed on the bottom of the radiator 1; the number of the lenses 1101 on the lens module board 11 is equal to the number of Light Emitting Diode light sources 3; the lens module board 11 covers the Light Emitting Diode light sources 3 and is sealed by waterproof ring 13, with one lens covers one Light Emitting Diode light source; the lens module board 11 is fixed on the bottom of the radiator 1. The structure adopts waterproof and optical integrated design, with simple and elegant outlook, reaching a very good waterproof effect without using glass board to separate the lenses and the outside.

The lenses 1101 on the lens module board 11 can use polarized lenses, producing polarized distribution light for large angle of lighting, achieving scattered lighting, having large lighting range.

In order to enhance the lighting protection effect of Light Emitting Diode luminaire, increase the safety and improve the working life of Light Emitting Diode luminaire, the power source 2 as set forth can be equipped with lighting arrester (not shown in the figure).

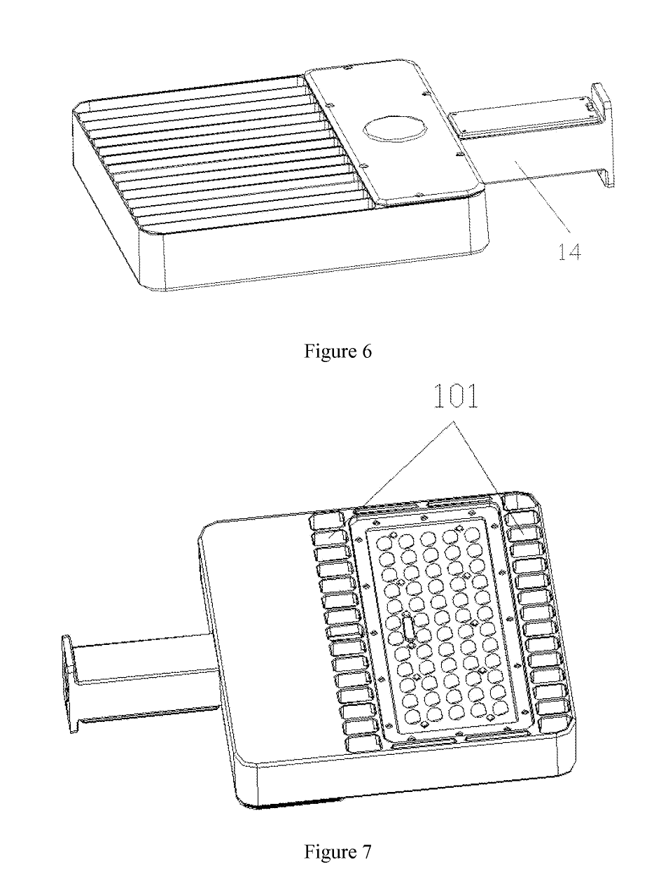

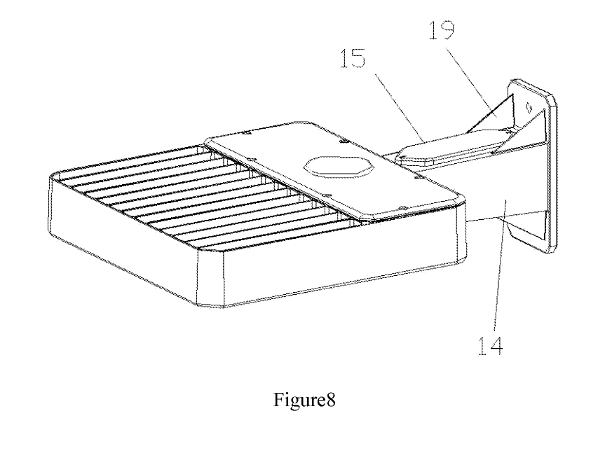

Please refer to FIGS. 5 and 6, the Light Emitting Diode luminaire can be fixed on the outside such as the external wall or lamp post etc. without the rotatable adapters, instead the Light Emitting Diode luminaire is connected to the outside with a fixed adapter 14, the fixed adapter is not a rotating one. The fixed adapter 14 holds down the silicone pad of the adapter and fixes on the radiator 1.

Please refer to FIG. 5, the fixed adapter 14 can be provided with a connection cover 15, under which a binding post 18 is set for connecting cables, facilitating the connection to external power supplies. The connection cover 15 holds down the silicone ring 16 of the cover and sits on the fixed adapter 14.

The connection cover 15 shown in FIGS. 5 and 6 is a square cover plate. FIG. 8 shows a new structure formed after simple change of the fixed adapter 14, its connection cover 15 is square in the center and triangle at both sides. At the end where the fixed adapter 14 is fixed to the outside, there is set one or more reinforced ribs so as to enhance the connection to the outside.

This invention Light Emitting Diode luminaire has good heat dissipation effect, easy for adjusting the angle. It adopts the waterproof and optical integrated design, with simple structure, good waterproof effect, wide lighting range, high safety and long service life.

The description above is only better embodiments of the invention, and is not used to limit this invention. It should be pointed out that for ordinary technicians in this field, any modification, equivalent replacement and improvement within the spirits and principles of the invention hereof shall fall into the protective range of the invention.

What is claimed is:

1. A Light Emitting Diode luminaire comprising a radiator, a power source and a plurality of Light Emitting Diode light sources, the power source connected with the Light Emitting Diode light sources electrically; wherein the power source is installed on the radiator, the radiator is equipped with through-holes that make its top and bottom connected.

2. The Light Emitting Diode luminaires as according to claim 1, wherein the radiator is equipped with a plurality of heat sinks with a gap between each two neighboring heat sinks.

3. The Light Emitting Diode luminaire according to claim 1, wherein the Light Emitting Diode luminaire is equipped with an adapter assembly, wherein one end of the adapter assembly is fixed on the radiator, and when in use the other end of the adapter assembly is fixed with the outside.

4. The Light Emitting Diode luminaire according to claim 1, wherein the adapter assembly comprises a first adapter and a second adapter, wherein the first adapter is fixed on the radiator, and the first adapter is connected to the second adapter through rotating activity connection, and when in use the second adapter is fixed with the outside.

5. The Light Emitting Diode luminaire according to claim 1, wherein the first adapter and the second adapter have tooth structures, and the two adapters can be connected through rotating activity of the tooth structures.

6. The Light Emitting Diode luminaire according to claim 1, wherein the first adapter is fixed on the radiator by a silicone pad, and the first adapter can connect to the second adapter by a silicone ring through rotating activity.

7. The Light Emitting Diode luminaire according to claim 1, wherein the Light Emitting Diode luminaire further comprises a lens module board and an aluminum substrate, the Light Emitting Diode light sources are all evenly distributed on the aluminum substrate which is fixed on the bottom of the radiator; the number of the lenses on the lens module board is equal to the number of the Light Emitting Diode light sources; the lens module board covers the Light Emitting Diode light sources and is sealed by a waterproof ring; with one lens covering one Light Emitting Diode light source, the lens module board is fixed on the bottom of the radiator.

8. The Light Emitting Diode luminaire according to claim 1, wherein the lenses of the lens module board are polarized lenses.

9. The Light Emitting Diode luminaire according to claim 1, wherein the material of the radiator is aluminum or copper.

10. The Light Emitting Diode luminaire according to claim 1, wherein the power source is equipped with lighting arrester.

11. The Light Emitting Diode luminaire according to claim 1, wherein the LED luminaire is provided with a fixed adapter, one end of the fixed adapter fixed on the radiator and the other end of the fixed adapter fixed on the outside.
